(19) United States
(12) Patent Application Publication
(10) Pub. No.: US 2015/0244187 A1
(43) Pub. Date: Aug. 27, 2015

(54) ELECTRONIC DEVICE

(71) Applicant: Kabushiki Kaisha Toshiba, Tokyo (JP)

(72) Inventor: Yutaka Horie, Mitaka (JP)

(21) Appl. No.: 14/482,809

(22) Filed: Sep. 10, 2014

Related U.S. Application Data
(60) Provisional application No. 61/944,947, filed on Feb. 26, 2014.

(51) Int. Cl. H02J 7/00

(52) U.S. Cl. CPC H02J 7/008

(57) ABSTRACT

According to one embodiment, a device includes a detector, a charging circuit, a notificator, and a measuring module. The detector detects an operating cycle for a battery having serially connected cells. The charging circuit charges the battery in accordance with a notified charging voltage value and a notified charging current value. The notificator notifies the charging circuit of a first charging current value and a first charging voltage value which is based on the operating cycle. The measuring module measures voltage values of the cells. The notificator notifies the charging circuit of the first charging voltage value and a second charging current value less than the first charging current value when a maximum voltage value of the voltage values exceeds a threshold voltage value.

### CROSS-REFERENCE TO RELATED APPLICATIONS

This application claims the benefit of U.S. Provisional Application No. 61/944,947, filed Feb. 26, 2014, the entire contents of which are incorporated herein by reference.

### FIELD

Embodiments described herein relate generally to a battery charging technology.

### BACKGROUND

Electronic device with built-in batteries, for instance, ultrabooks and tablet computers, is on the increase. However, since a battery is embedded in such device, it is difficult to replace it. It is therefore desired to prolong the useful life of the battery. Electronic device makers incorporate charge control techniques of their own into their individual systems to make the built-in batteries last longer.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of a piece of electronic device in one embodiment.

FIG. 2 is an exemplary block diagram illustrating a system structure of the piece of electronic device.

FIG. 3 is an exemplary block diagram illustrating a structure for battery charging.

FIG. 4 is an exemplary graph of charging voltage value against operating cycle.

FIG. 5 is an exemplary graph of charging current value against operating cycle.

FIG. 6 is an exemplary flowchart illustrating a procedure for battery charging.

FIG. 7 is a view illustrating the life of a battery.

### DETAILED DESCRIPTION

Various embodiments will be described hereinafter with reference to the accompanying drawings.

In general, according to one embodiment, an electronic device comprises a detector, a charging circuit, a notificator, and a measuring module. The detector is configured to detect an operating cycle for a battery having a plurality of serially connected cells. The charging circuit is configured to charge the battery in accordance with a notified charging voltage value and a notified charging current value. The notificator is configured to notify the charging circuit of a first charging current value and a first charging voltage value which is based on the operating cycle. The measuring module is configured to measure voltage values of the cells. The notificator is configured to notify the charging circuit of the first charging voltage value and a second charging current value less than the first charging current value when a maximum voltage value of the voltage values exceeds a threshold voltage value.

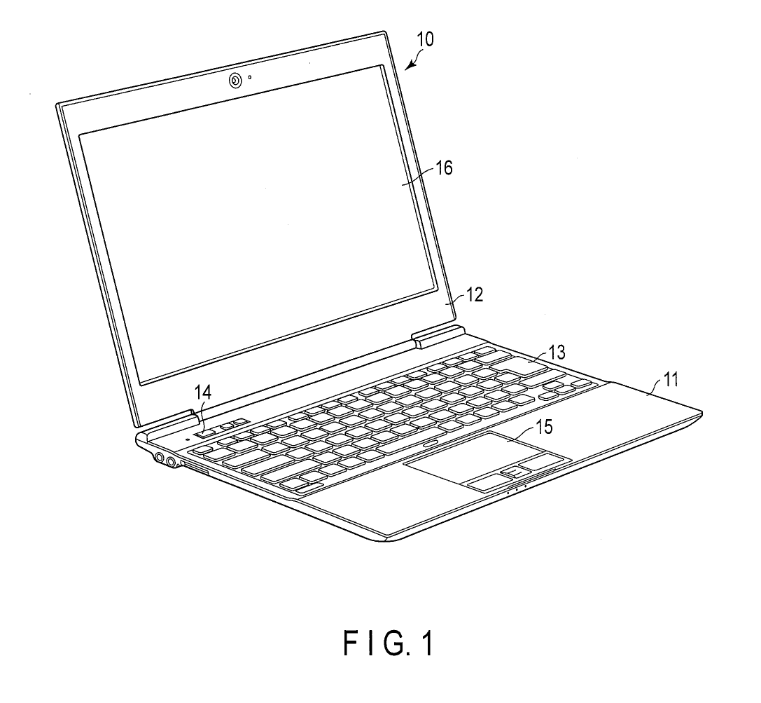

FIG. 1 is a view illustrating the external appearance of a piece of electronic device in the present embodiment. The electronic device includes a notebook computer, a tablet computer, a desktop computer, and so forth. The following explanation will be presented on the assumption that the electronic device in the present embodiment is embodied in a notebook computer 10.

FIG. 1 is a perspective view illustrating the front part of the computer 10, which is in a state in which its display unit is open. The computer 10 has a computer body 11 and a display unit 12. A display device such as a liquid crystal display device (LCD) 31 is installed in the display unit 12. Moreover, a camera (a web camera) 32 is provided on the upper end portion of the display unit 12.

The display unit 12 is attached to the computer body 11 in such a manner that it can freely swing between an open position, in which the upper surface of the computer body 11 exposes, and a closed position, in which the upper surface of the computer body 11 is covered with the display unit 12. The computer body 11 has a case of a thin box shape, on the top surface of which there are arranged a keyboard 13, a touchpad 14, a fingerprint sensor 15, a power switch 16 for rendering the computer 10 on or off, some functional buttons 17, and loudspeakers 18A, 18B.

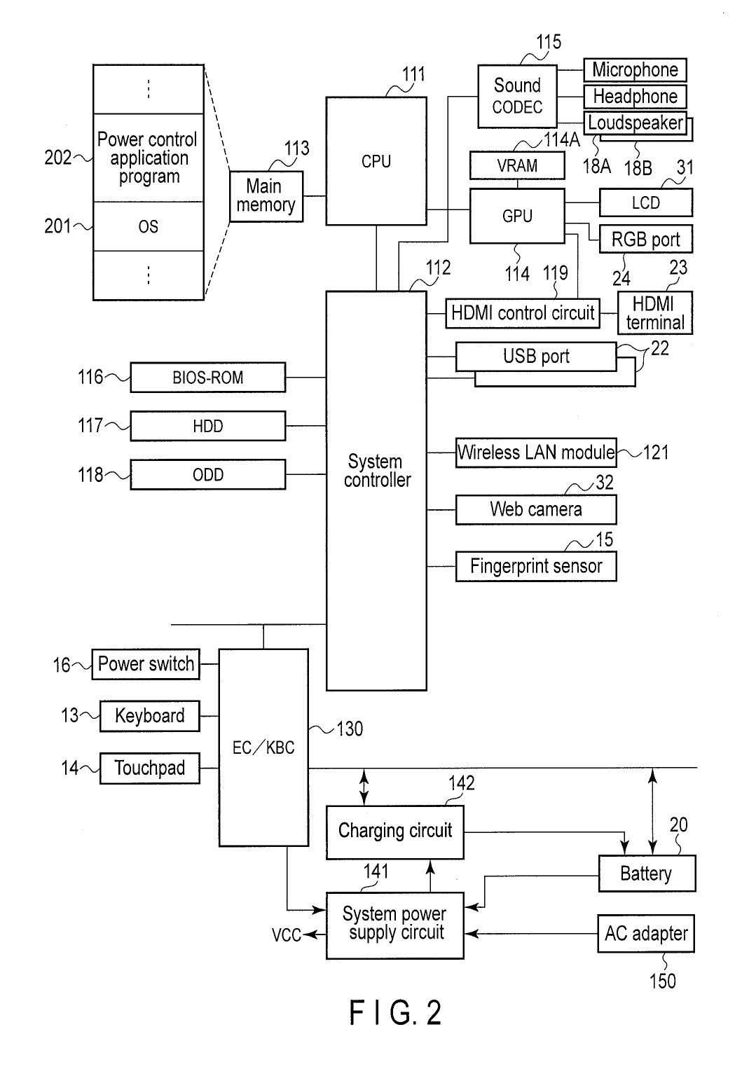

Furthermore, there is provided a power connector 21 at the computer body 11. The power connector 21 is provided at one of the side surfaces of the computer body 11. For instance, it is provided at the left side surface of the computer body 11. An external power supply is removably connected to the power connector 21. An AC adapter 150 (FIG. 2) may be used as the external power supply. The AC adapter converts a commercially available external power (an AC power) to a DC power.

A battery 20 (FIG. 2) is removably inserted into the rear end portion of the computer body 11. It does not matter if the battery 20 is a type of a battery that is embedded in the computer 10.

The computer 10 is driven by electric power from an external power supply or electric power from the battery 20. When the external power supply is connected to the power connector 21 of the computer 10, the computer 10 is driven by the power from the external power supply. The power from the external power supply is also used to charge the battery 20. While the external power supply is not connected to the power connector 21 of the computer 10, the computer 10 is driven by the power from the battery 20.

Furthermore, there is provided at the computer body 11 some USB ports 22, a High-Definition Multimedia Interface (HDMI) output connector 23, and an RGB port 24, all illustrated in FIG. 2.

FIG. 2 illustrates the system structure of the computer 10 in the embodiment. The computer 10 comprises a CPU 111, a system controller 112, a main memory 113, a graphics processing unit (GPU) 114, a sound CODEC 115, a BIOS-ROM 116, a hard disk drive (HDD) 117, an optical disc drive (ODD) 118, a wireless LAN module 121, an embedded controller/keyboard controller IC (EC/KBC) 130, a system power supply circuit 141, a charging circuit 142, and so forth.

The CPU 111 is a processer for controlling the operation of every component of the computer 10. The CPU 111 executes various programs loaded from the HDD 117 to the main memory 113. An operating system (OS) 201 and various application programs are included in the programs which the CPU 111 executes. A power control application program 202 is one of the various application programs. The power control application program 202 is a program for implementing a peak shift function. The peak shift function is a function for reducing electric power consumption during a period of time when the demand for electric power is high (in the case of being driven by AC power supply).

The CPU 111 also runs a basic input output system (BIOS) stored in the BIOS-ROM 116, which is a nonvolatile memory. The BIOS is a program for executing hardware control.

The GPU 114 is a display controller for controlling the LCD 31 used as a display monitor of the computer 10. The GPU 114 generates a display signal from the display data stored in a video memory (VRAM) 114A, and supplies the generated display signal to the LCD 31. Furthermore, the GPU 114 can generate from the display data both analog RGB signals and an HDMI video signal. The analog RGB signals are supplied through the RGB port 24 to an external display. An HDMI output connector 23 can send out the HDMI video signal (a non-compressed digital video signal) and the digital audio signal to the external display by means of a single cable. An HDMI control circuit 119 is an interface for sending out the HDMI video signal and the digital audio signal to the external display by means of the HDMI output connector 23.

The system controller 112 is a bridge device for connecting the CPU 111 to each of the components. The system controller 112 internally has a serial ATA controller for controlling the hard disk drive (HDD) 117 and the optical disc drive (ODD) 118.

The USB ports 22, the wireless LAN module 121, the web camera 32, the fingerprint sensor 15, and so forth are connected to the system controller 112.

The system controller 112 communicates with each device by means of a bus.

The EC/KBC 130 is connected through the bus to the system controller 112. The EC/KBC 130 is interconnected with each of the charging circuit 142 and the battery 20 by means of a serial bus.

The EC/KBC 130 is a power management controller for executing power management of the computer 10, and is embodied as a one chip microcomputer, which internally has a keyboard controller for controlling the keyboard (KB) 13 and the touchpad 14. The EC/KBC 130 has a function of causing the computer 10 to be rendered on or off according to the user's operation of the power switch 16. The control for causing the computer 10 to be turned on or off will be achieved by the system power supply circuit 141 under the control of the EC/KBC 130.

The charging circuit 142 charges the battery 20 under the control of the EC/KBC 130. The EC/KBC 130 and the system power supply circuit 141 will keep operating by means of the electric power supplied from the battery 20 or the AC adapter 150, even while the computer 10 is powered off.

The system power supply circuit 141 uses electric power from the battery 20 or from the AC adapter 150, which is connected to the computer body 11 as an external power source, and generates operating power, which is electric power to be supplied to each component. The system power supply circuit 141 also supplies electric power, which is used by the charging circuit 142 for charging the battery 20.

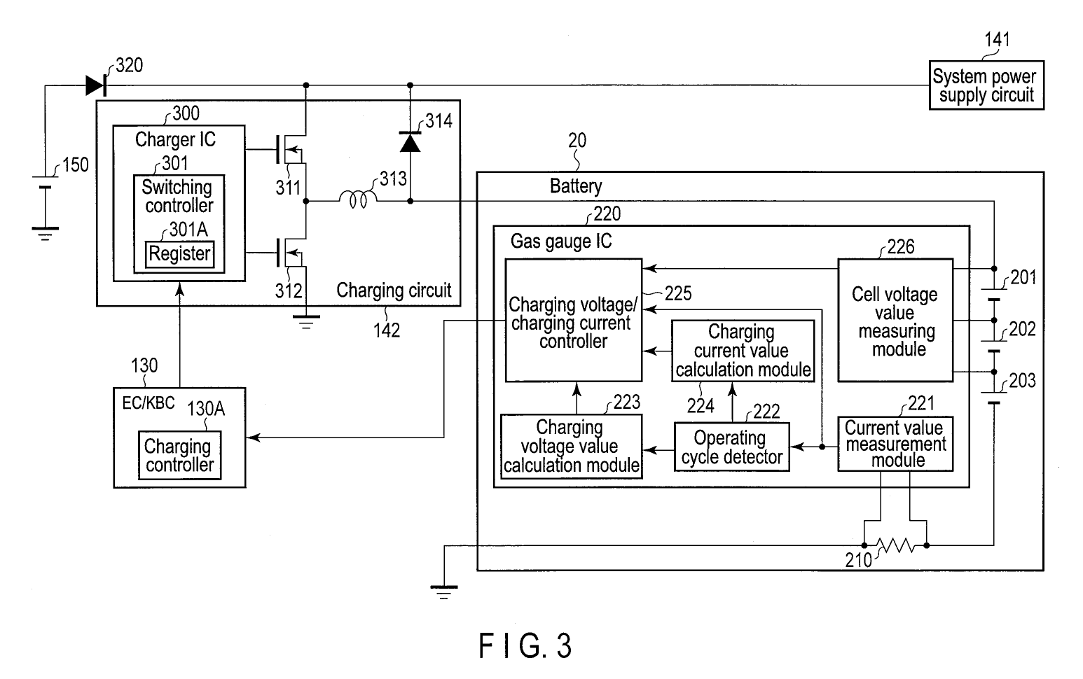

FIG. 3 is a block diagram illustrating a structure for charging the battery 20.

The direct-current power output from the AC adapter 150 is supplied through a diode 320 to the system power supply circuit 141 and the charging circuit 142.

The charging is executed under the control of the EC/KBC 130. At a charging start time the EC/KBC 130 inquires of the battery 20 about a recommended charging voltage value and a recommended charging current value. The battery 20 notifies the EC/KBC 130 of them in response to the inquiry. The EC/KBC 130 then notifies the charging circuit 142 of the recommended charging voltage value and the recommended charging current value. The EC/KBC 130 requests the charging circuit 142 to execute the constant-current charging according to the recommended charging current value.

After the charging has started, the EC/KBC 130 inquires of the battery 20 about a presently recommended charging voltage value, a presently recommended charging current value, the present voltage value of the battery 20 and the present current value of the battery 20. The battery 20 notifies the EC/KBC 130 of all of them in response to the inquiry. The EC/KBC 130 then notifies the charging circuit 142 of the presently recommended charging voltage value and the presently recommended charging current value. The EC/KBC 130 determines whether or not the present voltage value exceeds the presently recommended charging voltage value. In the case of the notified present voltage value exceeding the presently recommended charging voltage value, the EC/KBC 130 requests the charging circuit 142 to execute the constant-voltage value charging according to the presently recommended charging voltage value.

The charging circuit 142 comprises a charger IC 300, a high-voltage side switching element 311, a low-voltage side switching element 312, an inductor 313, a diode 314, and so forth.

The high-voltage side switching element 311 has a drain side, where the output from the AC adapter 150, a direct-current power supply source, is supplied. The high-voltage side switching element 311 has a source side, where the drain side of the low-voltage side switching element 312 is connected. The low-voltage side switching element 312 has a source side, which is grounded. The line connecting the source side of the high-voltage side switching element 311 and the drain side of the low-voltage side switching element 312 is connected through the inductor 313 to the battery 20. The battery 20 is connected through the diode 314 to the system power supply circuit 141.

The charger IC 300 charges the battery 20 under the control of the EC/KBC 130. The charger IC 300 has a switching controller 301. The switching controller 301 controls switching of the high-voltage side switching element 311 and of the low-voltage side switching element 312 at a time of charging the battery 20.

When the recommended charging voltage value and the recommended charging current value have been notified from the charger IC 300 to the charging circuit 142, the charger IC 300 causes a register 301A inside the switching controller 301 to hold the recommended charging voltage value and the recommended charging current value. The switching controller 301 controls switching of the switching elements 311 and 312 based on the held in the register 301A.

The switching controller 301 generates square wave voltage from input voltage by alternately rendering on the high-voltage side switching element 311 and the low-voltage side switching element 312, smoothes the square wave voltage by means of the inductor 313, and provides output voltage.

When the EC/KBC 130 requests that the constant-current charging should be executed in accordance with the recommended charging current value, the switching controller 301 controls switching of the switching elements 311 and 312 in order to achieve execution of the constant-current charging according to the recommended charging current value. When the EC/KBC 130 requests that the constant-voltage charging should be executed in accordance with the recommended charging voltage value, the switching controller 301 controls switching of the switching elements 311 and 312 in order to achieve execution of the constant-voltage charging according to the recommended charging voltage value.

The battery 20 has a plurality of cells 201, 202, 203, a resistor 210, a Gas gauge (GG) IC 220, and so forth. The cells 201, 202, 203 are connected in series. The serially connected cells 201, 202, 203 and the resistor 210 are connected in series.

A gas gauge IC 220 comprises a current measurement module 221, an operating cycle detector 222, a charging voltage value calculation module 223, a charging current value calculation module 224, a charging voltage/charging current controller 225, a cell voltage measuring module 226, and so forth.

The current value measurement module 221 obtains a measurement of the current value flowing through each of the cells 201, 202, and 203 by measuring the voltage value across the resistor 210. The operating cycle detector 222 detects a operating cycle by measuring a total output of the current supplied from the battery 20 to the system power supply circuit.

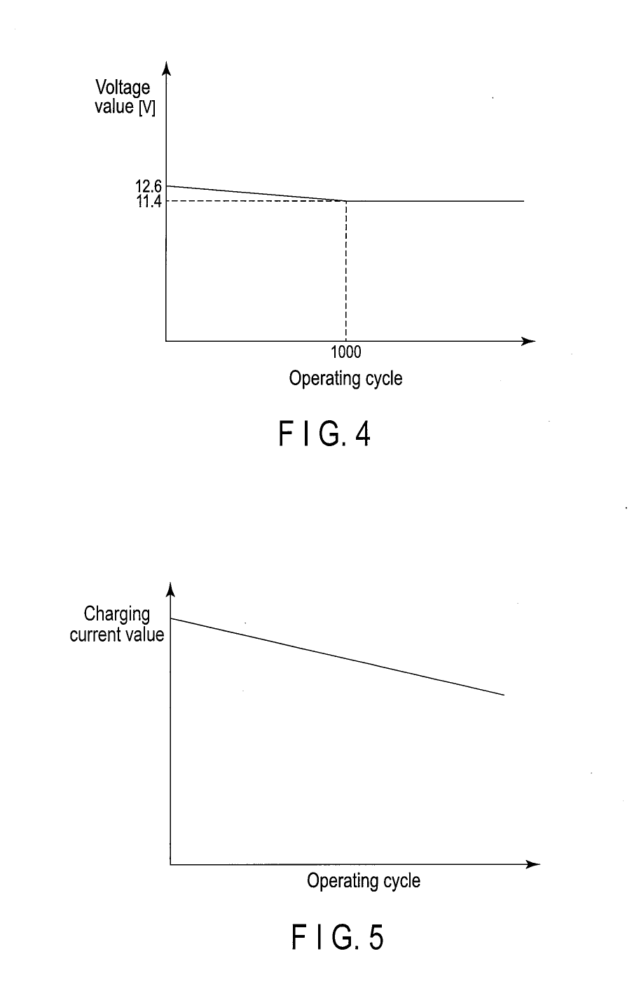

In a case where an inquiry about the recommended charging voltage value is made from the charging voltage/charging current controller 225 to the gas gauge IC 220, the charging voltage value calculation module 223 calculates the charging voltage value based on the operating cycle. The charging voltage value calculation module 223 notifies the charging voltage/charging current controller 225 of the calculated charging voltage value. For instance, the charging voltage value calculation module 223 has data indicating charging voltage values with respect to operating cycles, as illustrated in FIG. 4. It is therefore possible that the charging voltage value calculation module 223 calculates from the data illustrated in FIG. 4 the charging voltage value that corresponds to the operating cycle. It is also possible that the charging voltage value calculation module 223 calculates the charging voltage value based on the operating cycle and a using time of the battery.

In a case where an inquiry about the recommended charging current value is made from the charging voltage/charging current controller 225 to the gas gauge IC 220, the charging current value calculation module 224 calculates the charging current value based on the operating cycle. The charging current value calculation module 224 notifies the charging voltage/charging current controller 225 of the calculated charging current value. For instance, the charging current value calculation module 224 has data indicating charging current values with respect to operating cycles, as illustrated in FIG. 5. It is therefore possible that the charging current value calculation module 224 calculates from the data illustrated in FIG. 5 the charging current value that corresponds to the operating cycle. It is also possible that the charging current value calculation module 224 calculates the charging current value based on the fully charged present capacity of the battery. Alternatively, it may be possible to always use a constant charging current value.

In a case where an inquiry about the recommended charging current value and the recommended charging voltage value is made from the EC/KBC 130 to the gas gauge IC 220 for the first time after the charging has started, not only does the charging voltage/charging current controller 225 inquire the charging voltage value of the charging voltage value calculation module 223 but also it inquires the charging current value of the charging current value calculation module 224. The charging voltage/charging current controller 225 is notified of the charging voltage value in response to the inquiry, and sets it as the recommended charging voltage value. The charging voltage/charging current controller 225 calculates a threshold voltage value by dividing the notified charging voltage value by the number of the cells in the battery. It should be noted that the threshold voltage value must be less than the fully charged voltage value, which is set in accordance with any restriction by law. See FIG. 4, for example. Let us assume here that the fully charged voltage value of each cell in the battery is 4.2 V, for instance. Then, the recommended charging voltage value will be 12.6 V. Therefore, the threshold voltage value will be less than 4.2 V. The recommended charging voltage value then decreases with an increase in the operating cycle. In the example of FIG. 4, the recommended charging voltage value will be 11.4 V when the operating cycle reaches 1,000. At this moment, the threshold voltage value will be 3.8 V. The charging voltage/charging current controller 225 is notified of the charging current value in response to the inquiry, and sets it as the recommended charging current value. The charging voltage/charging current controller 225 notifies the EC/KBC 130 of the recommended charging voltage value and the recommended charging current value.

When an inquiry about the recommended charging current value and the recommended charging voltage value is made from the EC/KBC 130 from the second time onward after the charging has started, the charging voltage/charging current controller 225 inquires of the cell voltage value measuring module 226 the voltage value of each of the cells 201, 202, 203 in the battery.

The cell voltage measuring module 226 measures the voltage value of each of the cells 201, 202, 203 in the battery. The cell voltage value measuring module 226 notifies the charging voltage/charging current controller 225 of the measured voltage value of each of the cells 201, 202, 203 in the battery in response to the inquiry from the charging voltage/charging current controller 225.

The charging voltage/charging current controller 225 determines whether or not the maximum of the notified voltage values is higher than the threshold voltage value. When the maximum voltage value is higher than the threshold voltage value, the charging voltage/charging current controller 225 notifies the EC/KBC 130 of the charging current value which is one level lower than the charging current value, which it reported to the EC/KBC 130 the last time. The one level is 128 mA, for instance. In the case of the maximum of the notified voltage values exceeding the threshold voltage value, it is possible that the charging voltage/charging current controller 225 notifies the EC/KBC 130 of the fact, and that the EC/KBC 130 requests, in response to the notification, the charging circuit 142 to execute the constant-voltage charging according to the recommended charging voltage value.

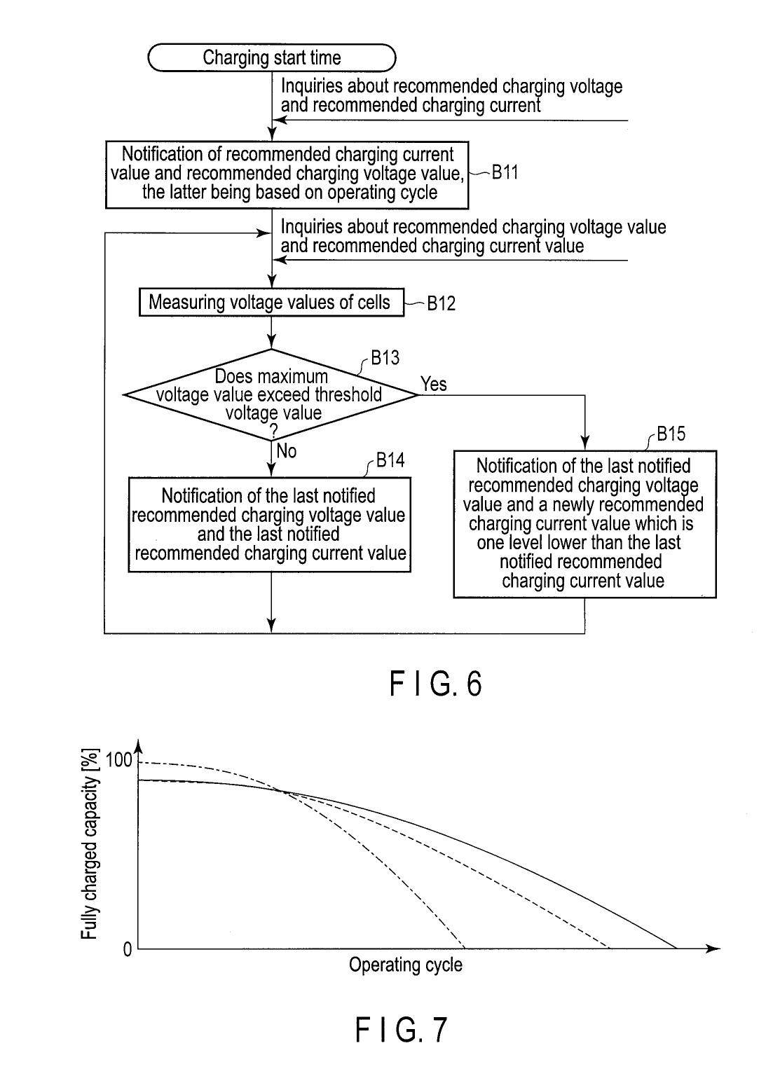

FIG. 6 is a flowchart illustrating a procedure for battery charging. The procedure for battery charging will be explained below with reference to FIG. 6.

At a charging start time the EC/KBC 130 inquires of the gas gauge IC 220 about a recommended charging voltage value and a recommended charging current value.

The charging voltage/charging current controller 225 notifies the EC/KBC 130 of the recommended charging current value and the recommended charging voltage value, the latter being based on the operating cycle (Block B11). The charging controller 130A in EC/KBC 130 notifies the charger IC 300 of the recommended charging voltage value and the recommended charging current value. The charger IC 300 causes the register 301A to hold the recommended charging voltage value and the recommended charging current value. The switching controller 301 controls switching of the switching elements 311 and 312 based on the recommended charging voltage value and the recommended charging current value, both being held in the register 301A. The charging of the battery 20 begins.

After the charging has started, the EC/KBC 130 regularly inquires of the gas gauge IC 220 about the recommended charging voltage value and the recommended charging current value. The charging voltage/charging current controller 225 inquires of the cell voltage value measuring module 226 about the voltage value of each of the cells 201, 202, 203 in the battery. The cell voltage value measuring module 226 measures the voltage value of each of the cells 201, 202, 203 in the battery (Block B12). The cell voltage value measuring module 226 notifies the charging voltage/charging current controller 225 of the voltage value of each of the cells 201, 202, 203 in the battery.

The cell voltage value measuring module 226 determines whether or not the highest (the maximum) of the notified voltage values exceeds the threshold voltage value (Block B13). If it is determined that the maximum voltage value does not exceed the threshold voltage value (No in Block B13), the charging voltage/charging current controller 225 notifies the EC/KBC 130 of the recommended charging voltage value and the recommended charging current value, which it reported to the EC/KBC 130 the last time (Block B14).

If it is determined that the maximum voltage value exceeds the threshold voltage value (Yes in Block B13), the charging voltage/charging current controller 225 notifies the EC/KBC 130 of the last notified recommended charging voltage value and a newly recommended charging current value which is one level lower than the last notified recommended charging current value (Block B16).

Blocks from B12 to B16 are repeatedly executed until the conditions of a fully charged battery are met. It should be noted that the voltage value of the battery at a time when charging has completed in the case where the battery has been charged by the charging system in the present embodiment will be less than the voltage value of the battery at a time when charging has completed in the case where the battery has been charged by the conventional charging system.

FIG. 7 is a view illustrating the fully charged capacity characteristics of the battery 20 with respect to the operating cycle. In FIG. 7, the fully charged capacity in the initial state is assumed to be 100%.

The solid line indicates that the fully charged capacity characteristics of the battery 20 with respect to the operating cycle in the case where the charging voltage value (the recommended charging voltage value) is calculated based on the operating cycle and where the charging current value is reduced when the maximum of the voltage values of the cells 201, 202, 203 in the battery exceeds the threshold voltage value. The broken line indicates that the fully charged capacity characteristics of the battery 20 with respect to the operating cycle in the case where the charging voltage value is calculated based on the operating cycle and where the charging current value is not reduced even when the maximum of the voltage values of the cells 201, 202, 203 in the battery exceeds the threshold voltage value. The alternate long and short dash line indicates that the fully charged capacity characteristics of the battery 20 with respect to the operating cycle in the case where the charging voltage value is not calculated based on the operating cycle and where the charging current value is not reduced even when the maximum of the voltage values of the cells 201, 202, 203 in the battery exceeds the threshold voltage value.

FIG. 7 apparently indicates that the life of the battery 20 will be prolonged by calculating the charging voltage value based on the operating cycle and by reducing the charging current value when the maximum of the voltage values of the cells 201, 202, 203 in the battery exceeds the threshold voltage value.

The electronic device in the present embodiment accomplishes prolongation of the life of a battery by calculating the charging voltage value of the battery based on the operating cycle and by reducing the charging current value when the maximum of the voltage values of the cells 201, 202, 203 in the battery exceeds the threshold voltage value.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
a detector configured to detect an operating cycle for a battery having a plurality of serially connected cells;
a charging circuit configured to charge the battery in accordance with a notified charging voltage value and a notified charging current value;
a notificator configured to notify the charging circuit of a first charging current value and a first charging voltage value which is based on the operating cycle; and
a measuring module configured to measure voltage values of the cells,
wherein the notificator is configured to notify the charging circuit of the first charging voltage value and a second charging current value less than the first charging current value when a maximum voltage value of the voltage values exceeds a threshold voltage value.

2. The device of claim 1, wherein the threshold voltage value is obtained by dividing the first charging voltage value by a count of the serially connected cells in the battery.

3. The device of claim 1, further comprising:
a calculator configured to calculate the first charging current value based on the operating cycle.

4. A charging method for a battery having serially connected cells, the method comprising:
detecting an operating cycle for the battery;
notifying a charging circuit, being configured to charge the battery in accordance with a notified charging voltage value and a notified charging current value, of a first charging current value and a first charging voltage value which is based on the operating cycle;
charging, by the charging circuit, the battery;
measuring voltage values of the cells; and
notifying the charging circuit of the first charging voltage value and a second charging current value less than the first charging current value when a maximum voltage value of the voltage values exceeds a threshold voltage value.
